(19) United States
(12) Patent Application Publication
(10) Pub. No.: US 2005/0264205 A1
(43) Pub. Date: Dec. 1, 2005

(54) Plasma display panel having improved exhaust efficiency

(76) Inventors: Byoung-Min Chun, Suwon-si (KR); Jeong-Nam Kim, Suwon-si (KR); Tae-Woo Kim, Suwon-si (KR); Jeong-Doo Yi, Suwon-si (KR)

Correspondence Address: MCGUIREWOODS, LLP, 1750 TYSONS BLVD, SUITE 1800, MCLEAN, VA, 22102, US

(21) Appl. No.: 11/138,210

(22) Filed: May 27, 2005

(30) Foreign Application Priority Data
May 31, 2004 (KR) 10-2004-0038927

(51) Int. Cl. H01J 17/49

(52) U.S. Cl. 313/584; 313/582

(57) ABSTRACT

A plasma display panel including a first substrate and a second substrate, a plurality of address electrodes, a plurality of display electrodes, and a barrier rib. The address electrodes and the display electrodes are formed between the first and second substrates. The barrier rib is disposed in a space between the first and second substrates and defines a plurality of discharge cells. A gas exhaust passageway is formed between discharge cells neighboring each other along a diagonal direction. The passageways and the discharge cells cooperatively form a gas exhaust route that repeats breaking away by a predetermined pitch, and returning, thereby zigzagging along an elongation direction of the address electrode.

### CROSS REFERENCE TO RELATED APPLICATION

This application claims priority to and the benefit of Korean Patent Application No. 10-2004-0038927, filed on May 31, 2004, which is hereby incorporated by reference for all purposes as if fully set forth herein.

### BACKGROUND OF THE INVENTION

1. Field of the Invention

The present invention relates to a plasma display panel. More particularly, the present invention relates to a plasma display panel having a barrier rib structure that may improve exhaust efficiency during combining and gas exhausting steps of a panel manufacturing process.

2. Discussion of the Background

Generally, a plasma display panel (PDP) is a display device that excites phosphors with vacuum ultraviolet rays radiated from plasma obtained through gas discharging, and displays desired images using red R, green G, and blue B colors generated by the excited phosphors. The PDP has several advantages. It may be made with a large screen of 60″ or more at 10 cm or less thick, and it produces excellent color representation without image distortion due to viewing angles. The PDP's relatively simple production process may result in higher productivity at a lower cost, as compared to a liquid crystal display panel.

FIG. 7 is a partial exploded perspective view showing a conventional alternating current (AC) PDP having a typical closed-type barrier rib structure.

Referring to FIG. 7, a conventional PDP may include a front substrate 111 and a rear substrate 112. Address electrodes 115 are formed on the rear substrate 112, and a dielectric layer 120 covers the address electrodes 115. A plurality of barrier ribs 117 are formed on the dielectric layer 120, and they partition a discharge space into discharge cells and prevent cross talk between cells. A phosphor layer 118 is formed in each discharge cell 119 surrounded by the barrier ribs 117. More specifically, the barrier ribs 117 of the PDP include a plurality of horizontal barrier ribs 117b, which are arranged substantially orthogonal to the address electrodes 115, and a plurality of vertical barrier ribs 117a, which are arranged substantially orthogonal to the horizontal barrier rib 117b. Such a closed-type barrier rib structure, as compared to a conventional structure in which a plurality of stripe-shaped barrier ribs are formed parallel with the address electrodes, may have improved discharge characteristics, since an area of the phosphor layer in the discharge cell 119 may be wider due to the horizontal barrier rib 117b, thereby allowing ultraviolet rays generated in the discharge cell 119 to more effectively excite the phosphors. Additionally, the closed-type barrier rib structure may be highly dense since it has barrier rib members between the cells, as compared to a stripe-type barrier rib structure.

Sustain electrodes 113 and 114 are formed on the front substrate 111, and a pair of sustain electrodes 113 and 114 are formed in each discharge cell 119. The sustain electrodes 113 and 114 are arranged substantially orthogonal to the address electrodes 115. Each sustain electrode 113 and 114 may comprise a transparent electrode 113a and 114a coupled with a bus electrode 113b and 114b, respectively. A dielectric layer 121 covers the sustain electrodes 113 and 114, and a protective layer 123 covers the dielectric layer 121.

In such a PDP, the front substrate 111 and the rear substrate 112 may be combined at their edges by a sealant, such as frit, thereby forming one panel. A through-hole for exhausting air and supplying a discharge gas may be formed on a substrate, such as the rear substrate 112, at a non-display region where discharge cells are not formed.

A typical air exhaust process includes two steps: a first air exhaust step for exhausting air by applying a pressure of about 10-7 Torr by connecting the through-hole to an exhaust device, and a second purge step for removing impurities inside the panel by injecting a purge gas (for example, Ne gas) into panel through the through-hole and subsequently exhausting gas from the panel.

However, in the PDP where barrier ribs surround the discharge cells on all sides, gas may not move well during gas exhaustion. Consequently, impurities may remain inside the PDP. If impurity gas remains inside the PDP, a poor discharge may occur while driving the PDP, thereby causing discharge lines or spots at various points of a PDP screen, which deteriorates display quality.

Therefore, a closed-type barrier rib structure that permits improved exhaustion of impurity gas is desired.

The information disclosed in this Background of the Invention section is only for enhancement of understanding of the background of the invention and therefore, unless explicitly described to the contrary, it should not be taken as an acknowledgement or any form of suggestion that this information forms the prior art that is already known in this country to a person of ordinary skill in the art.

### SUMMARY OF THE INVENTION

The present invention provides a PDP that may permit removal of impurity gases inside the panel during a gas exhausting process.

Additional features of the invention will be set forth in the description which follows, and in part will be apparent from the description, or may be learned by practice of the invention.

The present invention discloses a PDP including a first substrate and a second substrate, a plurality of address electrodes, a plurality of display electrodes, a barrier rib, and a passageway. The first and second substrates are disposed facing each other. The address electrodes are formed extending in a first direction between the first and second substrates. The display electrodes are formed in a second direction crossing the first direction between the first and second substrates. The barrier rib is disposed between the first and second substrates and defines a plurality of discharge cells. A passageway is formed between discharge cells neighboring each other along a diagonal direction, and passageways and discharge cells form an exhaust route zigzagging along the first direction by repeatedly breaking away by a predetermined pitch, and returning.

The present invention also discloses a PDP including a first substrate and a second substrate facing each other, a plurality of address electrodes between the first substrate and the second substrate and extending in a first direction, a plurality of display electrodes between the first substrate and the second substrate and extending in a second direction crossing the first direction, and a barrier rib between the first substrate and the second substrate and defining a plurality of discharge cells. The barrier rib is formed to define a passageway between discharge cells neighboring along a diagonal direction.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a top plan view partially showing a PDP according to a first exemplary embodiment of the present invention.

FIG. 2 is a top plan view partially showing an alternative configuration for a PDP according to the first exemplary embodiment of the present invention.

FIG. 3 is a top plan view partially showing a PDP according to a second exemplary embodiment of the present invention.

FIG. 4 is a top plan view partially showing a PDP according to a third exemplary embodiment of the present invention.

FIG. 5 is a sectional cutaway view along a line V-V of FIG. 4.

FIG. 6 is a top plan view partially showing a PDP according to a fourth exemplary embodiment of the present invention.

FIG. 7 is a partial exploded perspective view showing a conventional AC-PDP.

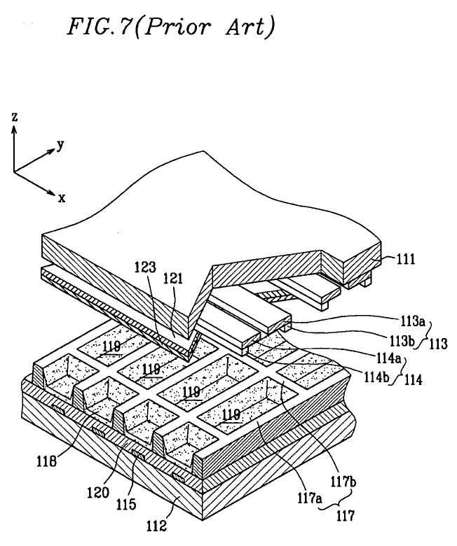

### DETAILED DESCRIPTION OF THE ILLUSTRATED EMBODIMENTS

Hereinafter, with reference to the accompanying drawings, embodiments of the present invention will be described in detail in order that those skilled in the art will be able to implement it. As those skilled in the art would realize, the described embodiments may be modified in various different ways, all without departing from the spirit or scope of the present invention. The same reference numbers refer to the same or like parts.

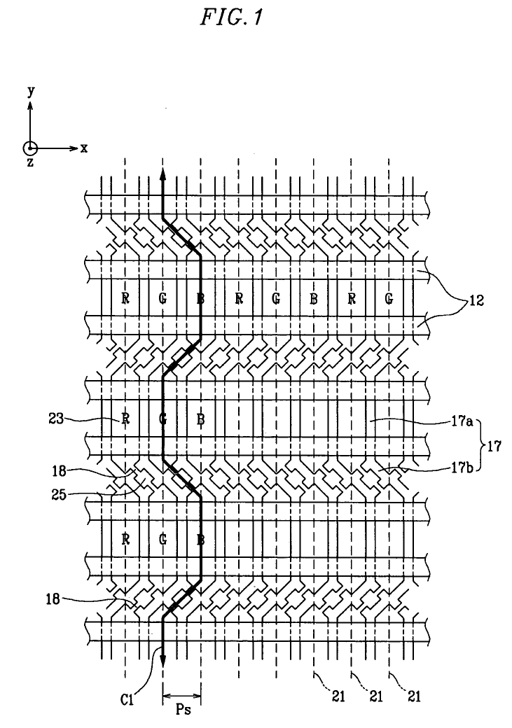

FIG. 1 is a top plan view partially showing a plasma display panel (PDP) according to a first exemplary embodiment of the present invention.

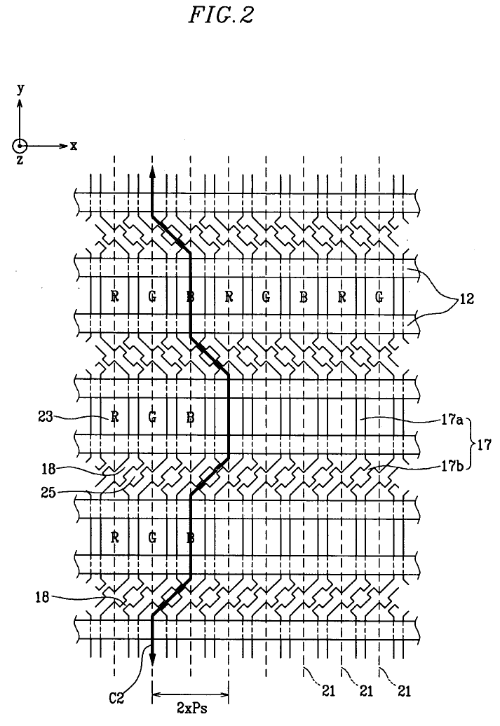

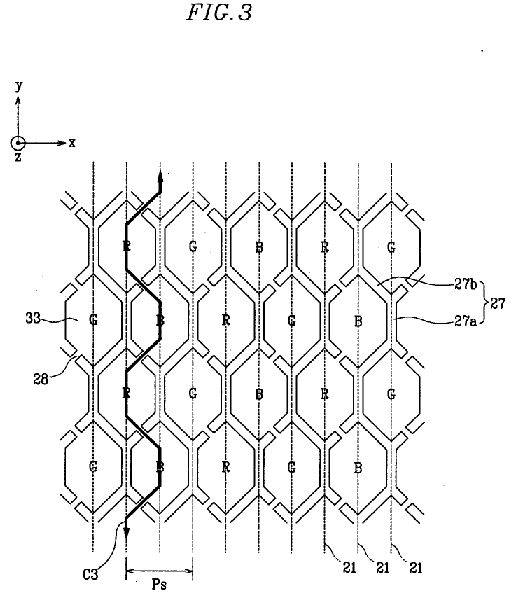

Referring to FIG. 1, the PDP according to the present embodiment may include a first substrate (not shown) and a second substrate (not shown) facing each other with a predetermined gap therebetween, and a barrier rib 17 partitions the space between the two substrates to define a plurality of discharge cells 23. A plurality of display electrode groups are formed along one direction (i.e., the x-axis direction in FIG. 1) on a surface of the first substrate facing the second substrate, and a plurality of address electrodes 21 are formed along a direction crossing the display electrode groups on a surface of the second substrate facing the first substrate. The address electrodes 21 shown in FIG. 1, as well as in FIG. 2 and FIG. 3, are illustrated as a line to simplify the drawings. However, the address electrodes 21 actually have a predetermined width.

The display electrode group selects a discharge cell to be lit, by discharge with the address electrode 21, and generates a sustain discharge to light the selected discharge cell. For example, the display electrode group may include a pair of display electrodes 12 corresponding to each discharge cell 23, as shown in FIG. 1. The display electrodes 12 extend along a direction crossing the address electrode 21, and each display electrode 12 may include a bus electrode and a transparent electrode. The transparent electrode may be made of a transparent material such as, for example, indium tin oxide (ITO), in order to secure an aperture ratio, and the bus electrode may be made of a metal in order to compensate for the transparent electrode's high resistance and secure sufficient electrical conductance. Alternatively, the display electrode 12 may be made of only a metal electrode. However, the present invention is not restricted to the above-stated structures.

The barrier ribs 17 form a plurality of discharge cell lines, and one discharge cell line includes a plurality of adjacent discharge cells disposed along a width direction thereof (i.e., x-axis direction in the drawing). Each discharge cell 23 forms a subpixel. In the PDP of FIG. 1, adjacent red R, green G, and blue B subpixels form one pixel, where the RGB subpixels forming one pixel are disposed in a single discharge cell line along a width direction of the discharge cell.

As FIG. 1 shows, a gas exhaust passageway 18 may be formed between discharge cells 23 neighboring along a diagonal direction. The gas exhaust passageways 18 and the discharge cells 23 form a gas exhaust route C1, and the gas exhaust passageway 18 is used to exhaust impurity gases from an inner space of the panel during a combining and gas exhausting step of a panel manufacturing process. In particular, the gas exhaust route C1 progresses along a direction the address electrode 21 extends while repeatedly breaking away by a predetermined pitch, running straight, and returning. Hence, the gas exhaust route C1 zigzags along the direction the address electrode 21 extends. The discharge cell 23 is closed to the discharge cell neighboring along another diagonal direction crossing the diagonal direction along which the gas exhaust passageway 18 is formed.

The barrier rib 17 may include a first barrier rib member 17a, which is formed in parallel with the address electrode 21, and a second barrier rib member 17b, which is formed crossing the address electrode 21. The second barrier rib member 17b is connected to the first barrier rib member 17a and thereby independently partitions each discharge cell 23, and the gas exhaust passageway 18 can be formed on the second barrier rib member 17b as a groove. The groove's maximum depth may equal the height of the second barrier rib member 17b, as FIG. 1 shows. In the present embodiment, the second barrier rib member 17b is formed as an X-shape between discharge cells neighboring along the direction the address electrode 21 extends (i.e. the Y direction). The second barrier rib member 17b partitions each discharge cell 23 and forms a non-discharge area 25 between discharge cells neighboring along the Y direction. The gas exhaust passageways 18 may pass through the non-discharge area 25.

In the panel according to the present embodiment, the gas exhaust passageway 18 is formed such that the gas exhaust route C1 repeats running straight, breaking away by one subpixel pitch Ps, running straight, and returning. Here, one subpixel pitch Ps may be defined as a distance between centers of a pair of discharge cells 23 neighboring along a direction the sustain electrode 12 extends (i.e. the X direction).

Since the gas exhaust route C1 has a zigzag shape as described above, gas exhaust efficiency may be equalized throughout positions within a display area of the panel, thereby maintaining uniform panel discharge characteristics.

The barrier rib 17 may be formed by, for example, sandblasting. If the barrier rib 17 is fabricated through a sandblasting process, the sandblasting may be performed by forming a barrier rib layer of a barrier rib material on the whole substrate and subsequently forming a laminator on the barrier rib layer. The laminator may act as a protective layer, and it has a pattern of a barrier rib. According to the present embodiment, a connection shape of the laminator may be uniform in a center portion and an edge portion, so that the protective layer of the edge portion may not be destroyed during the sandblasting process.

FIG. 2 is a top plan view partially showing an alternative configuration of a PDP according to the first exemplary embodiment of the present invention. Since the PDP of FIG. 2 has a similar discharge cell structure with the PDP of FIG. 1, detailed explanations for the same will be omitted.

Referring to FIG. 2, in this alternative configuration, the gas exhaust passageway 18 is formed such that the gas exhaust route C2 repeatedly breaks away by one subpixel pitch Ps, runs straight, breaks away by another subpixel pitch Ps, runs straight and then returns in the same pattern. Accordingly, the gas exhaust passageway 18 is formed such that the gas exhaust route C2 twice breaks away by one subpixel pitch (i.e. 2×Ps) before returning.

Furthermore, the gas exhaust passageway 18 may be formed such that the gas exhaust route repeats breaking away by a multiple of one subpixel pitch Ps, and running straight, before returning.

FIG. 3 is a top plan view partially showing a PDP according to a second exemplary embodiment of the present invention.

Referring to FIG. 3, the barrier ribs 27 form discharge cells 33 having a hexagonal planar shape. Each discharge cell 33 forms a subpixel, and one pixel consists of R, G and B subpixels disposed to form a triangular shape.

In the panel according to the present embodiment, a gas exhaust passageway 28 is formed between discharge cells 33 neighboring along a diagonal direction. The gas exhaust passageways 28 and the discharge cells 33 form a gas exhaust route C3, and the gas exhaust passageway 28 is used for exhausting impurity gases inside the panel during the combining and gas exhausting step of the panel manufacturing process. In particular, the gas exhaust route C3 progresses along a direction the address electrode 21 extends while repeatedly breaking away by a predetermined pitch, running straight, and returning. Hence, the gas exhaust route C3 zigzags and passes through the discharge cell 33 and the gas exhaust passageway 28. The discharge cell 33 is closed to the discharge cell neighboring along another diagonal direction crossing the diagonal direction along which the gas exhaust passageway 28 is formed.

In the panel according to the present embodiment, the gas exhaust passageway 28 is formed such that the gas exhaust route C3 repeats running straight, breaking away by a half of a subpixel pitch Ps, running straight, and returning. Here, the subpixel pitch Ps can be defined as a distance between centers of a pair of discharge cells 33 neighboring along a direction perpendicular to the address electrode 21. Alternatively, the gas exhaust passageway 28 may be formed such that the gas exhaust route repeats breaking away by a multiple of a half of the subpixel pitch Ps, and running straight, before returning.

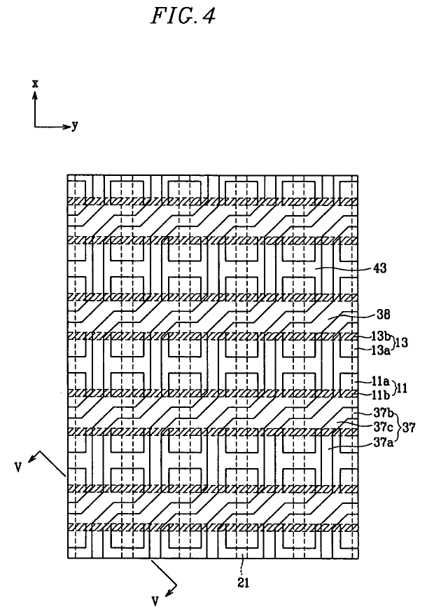

FIG. 4 is a top plan view partially showing a PDP according to a third exemplary embodiment of the present invention.

Referring to FIG. 4, a passageway 38 may be formed between discharge cells 43 neighboring along a diagonal direction. As FIG. 4 shows, the discharge cell 43 may be connected to the discharge cell neighboring along a diagonal direction through the passageway 38 and is closed to the discharge cell 43 neighboring along another diagonal direction crossing the diagonal direction along which the passageway 38 is formed.

A barrier rib 37 partitioning the discharge cells may include a first barrier rib member 37a, a second barrier rib member 37b, and a passageway barrier rib member 37c. The first barrier rib member 37a may be formed in parallel with a direction the address electrode extends (i.e., x-axis direction in FIG. 4), the second barrier rib member 37b may be formed crossing the direction the address electrode extends, and the passageway barrier rib member 37c may define the passageway 38 along a diagonal direction.

Here, the first barrier rib member 37a of one discharge cell 43 may be integrally formed with the second barrier rib member 37b and the passageway barrier rib member 37c of another discharge cell 43 neighboring along a diagonal direction and communicating with each other. Accordingly, the barrier rib 37 may be elongated with a meandering shape along a diagonal direction of a rectangular-shaped panel having a longer edge portion and a shorter edge portion, and a plurality of such barrier ribs 37 may be adjacently disposed to each other to partition each discharge cell 43.

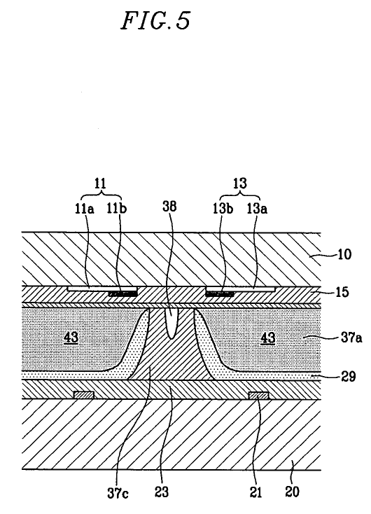

Referring to FIG. 5, the passageway barrier rib member 37c may be formed such that its height approximates the height of the first barrier rib member 37a, and the passageway 38 may be formed to be lower than the passageway barrier rib member 37c. A depth of the passageway 38 may vary depending on design and conditions of the barrier rib manufacturing process, and at a maximum, it may be equal to a depth of the discharge cell 43, as FIG. 4 shows. The depths of the passageway 38 and the discharge cell 43 can be defined as a distance between a top and bottom of the barrier rib member forming them.

Reference numerals 11 and 13 denote display electrodes, reference numerals 11a and 13a denote transparent electrodes, and reference numerals 11b and 13b denote bus electrodes, which are not explained hereinabove. Additionally, reference numerals 10 and 20 denote a first substrate and a second substrate, respectively, reference numerals 15 and 23 denote a first dielectric layer and a second dielectric layer, respectively, and reference numeral 29 denotes a phosphor layer.

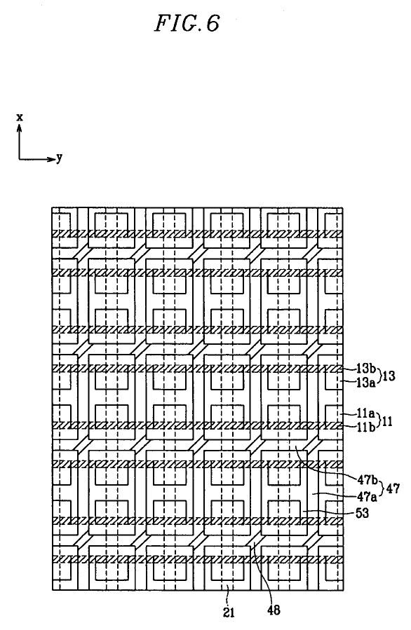

FIG. 6 is a top plan view partially showing a PDP according to a fourth exemplary embodiment of the present invention.

Referring to FIG. 6, a barrier rib 47 partitioning discharge cells may be formed by integrally connecting a vertical barrier rib member 47a, which is formed in parallel with the address electrode 21, and a horizontal barrier rib member 47b, which is formed crossing a direction the address electrode 21 extends.

Here, the discharge cells 53 along a diagonal direction are connected to each other through the passageway 48, which may be formed as a groove at a crossing point of the vertical barrier rib member 47a and the horizontal barrier rib member 47b. The groove may be formed on an upper surface of the barrier rib member 47.

According to exemplary embodiments of the present invention, a gas exhaust passageway may be formed between discharge cells neighboring along a diagonal direction. Hence, gas inside the panel may be effectively exhausted during the combining and gas exhausting process. Consequently, impurity gases remaining inside the panel may be minimized, thereby improving display quality.

Furthermore, since the gas exhaust route passing through the gas exhaust passageway and the discharge cells may have a zigzag shape, gas exhaust efficiency may be equalized throughout positions within a display area of the panel, thereby maintaining uniform panel discharge characteristics.

Additionally, since a connection shape of the laminator used as a protective layer may be uniform at center and edge portions, the protective layer of the edge portion may not be destroyed during the sandblasting process.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate and a second substrate facing each other;
a plurality of address electrodes between the first substrate and the second substrate and extending in a first direction;
a plurality of display electrodes between the first substrate and the second substrate and extending in a second direction crossing the first direction;
a barrier rib between the first substrate and the second substrate and defining a plurality of discharge cells; and
a passageway formed between discharge cells neighboring each other along a diagonal direction,
wherein passageways and discharge cells form an exhaust route zigzagging along the first direction by breaking away by a predetermined pitch and returning.

2. The PDP of claim 1, wherein:
the barrier rib includes a first barrier rib member in parallel with an address electrode and a second barrier rib member crossing the address electrode and connected to the first barrier rib member; and
the second barrier rib member includes the passageway.

3. The PDP of claim 2, wherein the passageway has a shape of a groove.

4. The PDP of claim 1, wherein passageways are formed such that the exhaust route repeats breaking away by one subpixel pitch and returning.

5. The PDP of claim 1, wherein passageways are formed such that the exhaust route repeats breaking away by a multiple of one subpixel pitch and returning.

6. The PDP of claim 1, wherein:
a non-discharge area is formed between the discharge cells neighboring each other along the diagonal direction; and
the passageway is formed such that the exhaust route passes through the non-discharge area.

7. The PDP of claim 1, wherein:
the discharge cells are arranged in a plurality of discharge cell lines, a discharge cell line including a plurality of discharge cells adjacently disposed along a width direction thereof; and
a red subpixel, a blue subpixel, and a green subpixel comprising one pixel are adjacently disposed in the discharge cell line.

8. The PDP of claim 1, wherein a pixel comprises a red subpixel, a blue subpixel, and a green subpixel disposed to form a triangular shape.

9. The PDP of claim 8, wherein passageways are formed such that the exhaust route repeats breaking away by a half of a subpixel pitch and returning.

10. The PDP of claim 8, wherein passageways are formed such that the exhaust route repeats breaking away by a multiple of a half of the subpixel pitch and returning.

11. The PDP of claim 1, further comprising a phosphor layer in the discharge cells.

12. A plasma display panel (PDP), comprising:
a first substrate and a second substrate facing each other;
a plurality of address electrodes between the first substrate and the second substrate and extending in a first direction;
a plurality of display electrodes between the first substrate and the second substrate and extending in a second direction crossing the first direction; and
a barrier rib between the first substrate and the second substrate and defining a plurality of discharge cells,
wherein the barrier rib is formed to define a passageway between discharge cells neighboring along a diagonal direction.

13. The PDP of claim 12, wherein a first discharge cell is connected to a second discharge cell neighboring along a first diagonal direction through the passageway, the first discharge cell being closed to a third discharge cell neighboring along a second diagonal direction crossing the first diagonal direction.

14. The PDP of claim 13, wherein the third discharge cell and the second discharge cell are neighboring to each other along the second direction.

15. The PDP of claim 12, wherein a height of a portion of the barrier rib defining the passageway approximates a height of a portion of the barrier rib defining a discharge cell, the passageway being formed to be lower than the height of the portion of the barrier rib defining the passageway.

16. The PDP of claim 12, wherein:
the barrier rib includes a first barrier rib member formed in the first direction, a second barrier rib member formed crossing the first direction, and a passageway barrier rib member defining the passageway; and
the first barrier rib member of a first discharge cell is integrally formed with the second barrier rib member and the passageway barrier rib member of a second discharge cell neighboring along the diagonal direction.

17. The PDP of claim 12, wherein:
the barrier rib includes a first barrier rib member formed in the first direction and a second barrier rib member formed crossing the first direction; and
the passageway is a groove formed along the diagonal direction at a crossing point of the first barrier rib member and the second barrier rib member, thereby connecting a pair of discharge cells neighboring along the diagonal direction with each other.
